(19) United States
(12) Patent Application Publication
(10) Pub. No.: US 2005/0245277 A1
(43) Pub. Date: Nov. 3, 2005

(54) Method of operating a communication system

(75) Inventors: Hardy Halbauer, Ettlingen (DE); Jean-Pierre Balech, Antony (FR); Michel Karaghiosian, Paris (FR); Heinz-Georg Krimmel, Korntal-Munchingen (DE); Michel Peruyero, Nanterre (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/103,611

(22) Filed: Apr. 12, 2005

(30) Foreign Application Priority Data
Apr. 28, 2004 (EP) 04291112.3

(51) Int. Cl. H04B 7/00

(52) U.S. Cl. 455/507; 455/500

(57) ABSTRACT

A communication system comprising a base station and a central office, the base station is used to establish a point-to-multipoint communication to a number of terminal stations and is coupled to the central office. The point-to-multipoint communication provided by that base station is used as a communication link between the central office and the base station.

### BACKGROUND OF THE INVENTION

The invention is based on a priority application EP 04291112.3 which is hereby incorporated by reference.

The invention relates to a method of operating a communication system, wherein the communication system comprises a base station and a central office, the base station is coupled to the central office and is used to establish a point-to-multipoint communication to a number of terminal stations.

The communication link between the base station and the central office serves to connect the base station and therefore the terminal stations to a core network. This communication link is known as backhaul connection. It is known to implement this communication link via a cable or a fiber. As well, it is known to connect the base station and the central office via a further point-to-point radio link operating with frequencies different from the frequencies of the point-to-multipoint communication provided by the base station.

The required efforts and costs for the known backhaul connections are high. In particular in areas with low-density communication traffic, these costs can only be shared among a low number of subscribers what leads to increased costs per subscriber.

### SUMMARY OF THE INVENTION

It is an object of the invention to provide a method of operating a communication system with a less expensive backhaul connection.

The invention solves this object by a method of operating a communication system, the communication system comprising a base station and a central office, wherein the base station is used to establish a point-to-multipoint communication to a number of terminal stations and is coupled to the central office, and wherein the communication link between the central office and the base station uses the point-to-multipoint communication provided by that base station.

The object is also solved by a communication system comprising a base station and a central office, wherein the base station is used to establish a point-to-multipoint communication to a number of terminal stations and is coupled to the central office, and wherein the point-to-multipoint communication provided by the base station is used as a communication link between the central office and that base station; and by a base station for a communication system, used to establish a point-to-multipoint communication to a number of terminal stations and coupled to a central office of the communication system, wherein the point-to-multipoint communication provided by that base station is used as a communication link between the central office and the base station.

The invention, therefore, only requires little efforts or costs to establish the communication link between the central office and the base station. The invention uses the point-to-multipoint communication that is provided by the base station and that is already present in order to implement the communication link between the central office and the base station. For this use, it is only necessary to adopt the operating procedures of the base station and the central office.

In embodiments of the invention, the base station sends data received by the base station from one of the terminal stations, to the central office via the point-to-multipoint communication provided by the base station, and the base station receives data addressed to one of the terminal stations from the central office via the point-to-multipoint communication provided by the base station.

According to the invention, the above object is also solved by a respective communication system or by a respective base station for a communication system.

In further embodiments of the invention, the base station comprises a beam forming antenna, in particular a smart antenna, for concentrating the beam of the antenna in the direction of the central office, and/or the central office comprises a directional antenna being directed in the direction of the base station. With these measures, the distance between the central office and the base station may be increased.

Further features, applications and advantages of the invention will become apparent from the following description of exemplary embodiments of the invention that are shown in the drawings. There, all described and shown features themselves or in any combination represent the subject matter of the invention, independently of their wording in the description or their representation in the drawings and independently of their combination in the claims or the dependencies of the claims.

### BRIEF DESCRIPTION OF THE DRAWING

FIG. 1 shows a schematic block diagram of an embodiment of a communication system according to the invention.

### DETAILED DESCRIPTION OF THE DRAWING

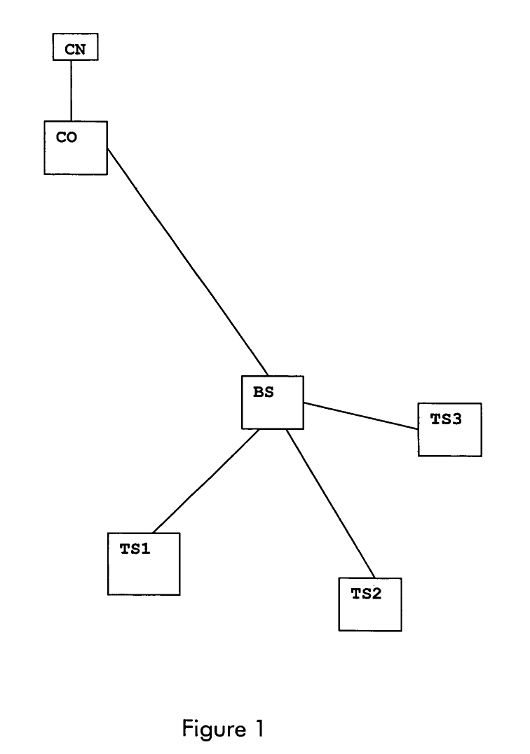

In FIG. 1, a base station BS and a number of terminal stations TS1, TS2, TS3 are shown.

The base station BS is located at a fixed location and serves as a point-to-multipoint radio receiver/transmitter. A cell or sector is defined around the base station BS in which terminal stations may communicate with the base station BS. The terminal stations TS1, TS2, TS3 shown in the FIGURE, are situated within this cell or sector.

The terminal stations TS1, TS2, TS3 are fixed or mobile receivers/transmitters and are established as subscribers for communicating with the base station BS.

The base station BS is coupled to a core network CN via a central office CO. This connection is usually called a backhaul connection.

According to the invention, the central office CO is established as a further subscriber of the base station BS and is realized as a kind of terminal station. The properties of the central office CO and the properties of the terminal stations TS1, TS2, TS3 are the same with regard to an uplink transmission or to a downlink transmission. For that purpose, the central office CO may comprise a subscriber station that is similar to the terminal stations TS1, TS2, TS3.

If, for example, the terminal station TS2 wants to send data to a receiver being located somewhere within the core network CN, the terminal station TS2 transmits this data to the base station BS. In this upstream transmission, the address of the base station BS is used as the actual address of the data.

The base station BS receives the data and admits the data due to the actual address of the data. The base station BS assigns the address of the central office CO as the actual address of the data. Then, the base station BS transmits the data in a downlink transmission together with the assigned actual address.

The central office CO receives the data and admits the data due to the assigned actual address of the data. Then, the central office CO processes the data and forwards the data to the core network CN for further transmission.

The same procedure is carried out if another one of the terminal stations TS1, TS3 wants to send data to a receiver.

All data sent by the terminal stations TS1, TS2, TS3 as an uplink transmission is collected by the base station BS and is then forwarded from the base station BS to the central office CO as a downlink transmission. In the first-mentioned transmission, all data has the base station BS as the actual address. In the second-mentioned transmission, all data from the different terminal stations TS1, TS2, TS3 have the same actual address, i.e. the address of the central office CO. From the central office CO, the data is then processed for further transmission within the core network CN.

If, for example, data shall be sent to the terminal station TS3, the data is received from the core network CN by the central office CO. The central office CO transmits the data in an uplink transmission to the base station BS. The actual address being assigned to the data is the address of the base station BS.

Then, the base station examines the data and elaborates which one of the terminal stations TS1, TS2, TS3 is the destination of the data. The address of this terminal station, i.e. the terminal station TS3, is then assigned as the actual address to the data. Then, the data is transmitted in a downlink transmission from the base station BS to all terminal stations TS1, TS2, TS3. Due to the assigned actual address, the respective terminal station TS3 receives and admits the data.

The same procedure is carried out if data shall be sent to another one of the terminal stations TS1, TS3.

All data that shall be sent to one of the terminal stations TS1, TS2, TS3 is transmitted from the central office CO to the base station BS as an uplink transmission and is then distributed by the base station BS to the terminal stations TS1, TS2, TS3 as a downlink transmission. In the first-mentioned transmission, the data for the different terminal stations TS1, TS2, TS3 have the same actual address, i.e. the address of the base station BS. In the second-mentioned transmission, the address of the destination, i.e. the respective terminal station, is assigned to the respective data.

It is now assumed that the base station BS and therefore the point-to-multipoint communication between the base station BS and the terminal stations TS1, TS2, TS3 is carried out according to a time-division-duplex (TDD) method. Then, the uplink and the downlink transmission to and from the base station BS are carried out consecutively with one and the same frequency. The data received by the base station BS from the terminal stations TS1, TS2, TS3 in an uplink transmission is therefore forwarded from the base station BS to the central office CO in a subsequent downlink transmission. It is possible that the data has to be stored in the base station BS in order to bridge the time from the uplink transmission to the downlink transmission.

As the address of the central office CO is assigned as the actual address to the data in the downlink transmission, the terminal stations TS1, TS2, TS3 may receive these data but will not admit these data.

The same is valid for a transmission from the central office CO to one of the terminal stations TS1, TS2, TS3 via the base station BS.

It is now assumed that the base station BS and therefore the point-to-multipoint communication between the base station BS and the terminal stations TS1, TS2, TS3 is carried out according to a frequency-division-duplex (FDD) method. Then, the uplink and the downlink transmission to and from the base station BS are carried out in parallel with two different frequencies. The data received by the base station BS from the terminal stations TS1, TS2, TS3 in an uplink transmission therefore may be forwarded at once from the base station BS to the central office CO in a downlink transmission, without the requirement to store the data.

Again, due to the assigned actual addresses, the correct receivers will always admit the respective data. As the data may be forwarded at once from the uplink transmission to the downlink transmission, no storage is necessary. The some is valid for an opposite transmission.

Due to the fact that all transmissions that are carried out in an uplink direction, are also transmitted in a downlink direction and vice versa, the sum of all uplink transmissions is equal to the sum of all downlink transmissions, even if the uplink and the downlink transmissions ratio of the subscribers varies. This always leads to a symmetrical utilization of the FDD-frequencies.

As described, the communication link between the base station BS and the central office CO is identical to any other communication link between the base station BS and one of the terminal stations TS1, TS2, TS3. Insofar, the same resource, i.e. the point-to-multipoint communication provided by the base station BS is used as the backhaul connection to the core network CN. Therefore, no additional efforts, in particular no additional costs are necessary to establish this backhaul connection.

However, the mentioned communication link between the base station BS and the central office CO may be improved by the following additional measures. A prerequisite of these measures is that the central office CO is located at a fixed location.

It is possible to use a so-called smart antenna within the base station BS. If, then, the base station BS transmits or receives data to or from the central office CO, the base station BS can increase the quality of this communication link by concentrating the beam of the antenna in the known direction of the central office CO. This smart antenna is commonly used within base stations so that it only requires additional control efforts to carry out the described concentration of the beam. Instead of the smart antenna, other directional antennas may also be used.

Alternatively or additionally, it is possible to use a directional antenna within the central office CO that is directed into the known direction of the base station BS. This directional antenna would require additional hardware costs. However, as only one central office CO is present, the costs are low compared to the cost savings by using the point-to-multipoint communication provided by the base station BS as the communication link between the base station BS and the central office CO.

Furthermore, alternatively or additionally, for the communication link between the central office CO and the base station BS, the antennas may be installed with line-of-sight (LOS).

With these measures, it is possible that the central office CO is located at a location that is at a larger distance from the base station BS. In particular, it is possible to locate the central office CO outside of the cell or sector defined by the base station BS.

1. A method of operating a communication system, the communication system comprising a base station and a central office, wherein the base station is used to establish a point-to-multipoint communication to a number of terminal stations and is coupled to the central office, and wherein the communication link between the central office and the base station uses the point-to-multipoint communication provided by that base station.

2. The method of claim 1, characterized in that the base station sends data received by the base station from one of the terminal stations, to the central office via the point-to-multipoint communication provided by the base station.

3. The method of one of claim 1, characterized in that base station receives data addressed to one of the terminal stations from the central office via the point-to-multipoint communication provided by the base station.

4. A communication system comprising a base station and a central office, wherein the base station is used to establish a point-to-multipoint communication to a number of terminal stations and is coupled to the central office, and wherein the point-to-multipoint communication provided by that base station is used as a communication link between the central office and the base station.

5. The communication system of claim 4, characterized in that the base station comprises a beam-forming antenna, in particular a smart antenna, for concentrating the beam of the antenna in the direction of the central office.

6. The communication system of claim 4, characterized in that the base station comprises a directional antenna for concentrating the beam of the antenna in the direction of the central office.

7. The communication system of claim 4, characterized in that the central office comprises a directional antenna being directed in the direction of the base station.

8. The communication system of claim 4, characterized in that the central office is located outside of a cell or sector defined by the point-to-multipoint communication provided by the base station.

9. A base station for a communication system, being used to establish a point-to-multipoint communication to a number of terminal stations and coupled to a central office of the communication system, wherein the point-to-multipoint communication provided by that base station is used as a communication link between the central office and the base station.

10. The base station of claim 9, characterized in that the base station comprises a beam-forming antenna, in particular a smart antenna, for concentrating the beam of the antenna in the direction of the central office.

11. The base station of claim 9, characterized in that the base station comprises a directional antenna for concentrating the beam of the antenna in the direction of the central office.
